(19) United States
(12) Patent Application Publication
(10) Pub. No.: US 2012/0023804 A1
(43) Pub. Date: Feb. 2, 2012

(54) WEIGHTED SOFT-BAIT FISHING LURE

(76) Inventor: Michael P. Hogan, Falmouth, MA (US)

(21) Appl. No.: 12/848,216

(22) Filed: Aug. 1, 2010

(51) Int. Cl. A01K 85/00

(52) U.S. Cl. 43/42.39; 43/42.24; 43/44.2

(57) ABSTRACT

The present invention provides an improved weighted soft-bait fishing lure that includes a jighead assembly, comprising a weight having a generally elongate body with a first longitudinal axis, a hook and a bait keeper means, and a bait having an generally elongate body with a second longitudinal axis, wherein the bait is releasably connected to the jighead assembly at the bait keeper means such that the first longitudinal axis of the weight and the second longitudinal axis of the bait are generally in line with one another.

### INCORPORATION BY REFERENCE

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the invention.

### BACKGROUND OF THE INVENTION

1. Field of the Invention

The present invention relates to fishing lures, and in particular, to weighted soft-bait fishing lures comprising a weighted jig head interfaced with a soft-bait that provides an effective natural presentation during use.

2. Description of the Related Art

The sport of fishing with artificial lures for game fish, such as large mouth bass, small mouth bass, pike, walleye, and a variety of saltwater game fish, such as, striped bass and bluefish, is a highly popularized sport. Much money is spent each year on a variety of equipment, lures, boats and other gear that is used and/or needed in fishing. The popularity of fishing is evidenced by numerous fishing-related publications, fishing-related television programming, fishing-related internet websites, products, and the popularity of amateur and professional tournaments.

A large variety of lures have been designed and manufactured to assist the catching of fish, such as bass, bluefish and tuna. These lures are made in a variety of shapes, sizes, colors, textures and weights and are made from a whole range of materials, from metals, to plastics and to soft plastics and rubbers. Indeed, the plethora of different lures known in the art are reflective of the great variety of different fishing applications and techniques that are available and utilized in the sport of fishing. The immense variety of these applications and techniques in turn reflect the great variety of target fish, weather conditions, water conditions (e.g. fresh water, salt water, stream water, estuary water, shallow or deep water), and geographical locations that may exist in any given fishing experience. For example, a fisherman interested in “pulling” bass may choose from variety of “topwater” and “subsurface” techniques and use a variety of available lures, including commonly known lures such as buzzbaits (e.g. the Squeaky Dolphin Buzz), walking baits (e.g. the Zara Spook, the Gilmore Oddball, the MirroLure Top Dog), poppers (e.g. Argoblast Hula Popper), propeller ripping bait (e.g. the Gilmore Jumper, the Gilmore Go Getter, the Hedden Bay Torpedo, and the Smithwick Devil's Horse), soft plastic jerk baits (e.g. the Lunker City Slug-Go, the Bass Assassin), and crankbaits (e.g. the Bill Lewis Rat-L-Trap and the Cordell Hot Spot). In other examples, a fisherman may wish to target fish located at deeper levels in the water column; thus, use of weighted fishing lures can be appropriate in order to send the lure below the subsurface.

It is generally appreciated to the skilled artisan that lures are used to catch fish by mimicking bait (living or dead organism) in shape, size, smell, sound, appearance and action. The closer the action and appearance of the lure to the actual bait it is imitating, the more effective lure will generally be at catching fish. The fishing lure industry is constantly refining and improving fishing lures to better mimic the shape, size, smell, sound, appearance, color and action of bait in order to allow fishermen to be successful. Sight and appearance play an important role, if not the most important role, in fish feeding habits, and fishermen are constantly seeking better and ever more effective lures.

One of the main areas of emphasis in recent years has been the growing popularity of soft plastic lures. Soft plastic lures encompass a range of soft plastic-based fishing lures, termed so because of their soft, flexible rubber textures. They are designed to imitate fish or other natural aquatic food sources and can have a realistic textures and versatility. These features, combined with simple and economical production qualities, have led them to become a standard article of modern fishing tackle. Soft plastics are available in a diverse range of colors, sizes and particular shapes, as well as rigging arrangement, i.e., how the hook or hooks interact with and/or are presented in the soft bait portion of the lure.

As the soft plastic baits tend to impart a buoyancy to the lure, weighted jigheads or other types of weights can be integrated with the lure to allow the angler to move the lure into lower regions of the water column. A weighted jighead typically includes one or more hooks and a keeper system (e.g., a thread or needle) each attached in some manner to a central weight that allows the completed lure to move down the water column. The soft plastic bait is attached to the jighead via the keeper system. The hook is typically embedded through the bait to help retain the bait on the jighead. The fishing line is attached at the front end of the jighead.

However, currently known weighted jighead soft plastic lures, have several disadvantages which are addressed by the present invention.

One disadvantage is that the weighted jighead soft plastic lures are typically constructed in a manner that imparts unnatural movement characteristics during its use which do not readily imitate the natural intended bait (e.g., worms, eel, small fish, crawdad, etc.). In other words, such lures are less realistic looking than is desired. For example, one common problem of many weighted jighead soft plastic lures is that the lure is imparted with an up and down motion as it is pulled through the water by the angler. This up and down motion—as opposed to a side-to-side motion—is not characteristic of the natural bait that the soft plastic lure is intended to imitate. Thus, this disadvantage mitigates the effectiveness of the lure's ability to attract fish.

Another disadvantage of weighted jighead soft plastic lures is that the bait portion tends to become destroyed when a fish bites the lure and/or as the angler reels in a hooked fish which is actively fighting to be released from the hook. The degradation of the soft plastic bait portion is in part due to the fact that the hook is typically in contact with or inserted through the bait.

Yet another problem with current weighted jighead soft plastic lures is that it can be difficult and time consuming to change the bait element. In some conditions, one type of bait can be more effective for attracting fish than another type of bait. This can be based on the type of fish, the environmental conditions and the underwater conditions. The angler who begins the day under certain conditions may find that the conditions change throughout the day and the lure or live bait system they began with is no longer effective. In this situation, the angler may want to change the lure or bait being used. However, the time needed to change the bait system consumes valuable fishing time at a time when the fish may be striking. It would be advantageous to have a weighted jighead soft plastic lure which is easily changeable.

Prior art devices fail to solve these problems. In one device, as described in U.S. Pat. No. 7,140,146 to Gill, a jighead soft plastic fishing lure is provided which includes a weight body connected to a hook and a bait keeper. However, due to the configuration of the different elements, this type of lure would produce an unnatural and undesirable up and down movement in the water, which would be less appealing to fish. Specifically, the location of the weight body relative to the bait (i.e., the weight is below the longitudinal axis of the bait) and the shape of the hook (hook eye is above center of gravity of the weight) would impart the lure with an unnatural up and down movement in the water. Further, the hook is embedded into the bait body, making the bait much more rigid in that region; and thus, less flexible and natural-looking in its movement. Further still, the embedded hook would lead to destruction of the bait once the fish is in contact with the hook and attempts to fight itself off of the lure.

In another device, described in U.S. Pat. No. 5,220,743 to McClellan, a jighead soft plastic fishing lure is provided which includes a hook, a bait keeper (element 16) and a weight. However, the arrangement of these features fails to produce a lure with a realistic movement, or even a lure where the bait is protected from destruction by the fish. Specifically, the hook is embedded into the bait creating a very stiff region of the bait which prevents it from achieving a more realistic look while it travels through the water. Further, the line attachment point, the weight and the bait are not in line with one another. This arrangement would tend to impart an unnatural up and down or jerky movement.

Other similar lure devices are described in U.S. Pat. No. 5,784,827 to Jimenez et al., D474,5235 to Renosky, U.S. Pat. No. 4,841,665 to McGahee, U.S. Pat. No. 5,025,586 to Pixton and U.S. Pat. No. 5,152,094 to Strickland. However, these lure systems, like those described above, fail to solve the problems already noted in the prior art.

Accordingly, an improved weighted jighead soft plastic lures that cures the above drawbacks and disadvantages is desired and would advance the art.

### SUMMARY OF THE INVENTION

The purpose and advantages of the present invention will be set forth in and apparent from the description that follows. Additional advantages of the invention will be realized and attained by the methods and systems particularly pointed out in the written description and claims hereof, as well as from the appended drawings.

Accordingly, in one aspect, the present invention provides a fishing lure comprising:
a jighead assembly, comprising a weight having a generally elongate body with a first longitudinal axis, a hook and a bait keeper means, and
a bait having a generally elongate body with a second longitudinal axis, wherein the bait is releasably connected to the jighead assembly at the bait keeper means such that the first longitudinal axis of the weight and the second longitudinal axis of the bait are generally in line with one another.

In another aspect, the present invention provides a fishing lure, comprising:

a weight body having a generally elongate body with a longitudinal axis, a first end and a second end, wherein the two ends are generally opposite one another along the first longitudinal axis, a top side, a bottom side, a left side and a right side,

a hook, wherein the hook passes through the weight body such that the eyelet of the hook extends outward from the first end of the weight body, the hook flank is generally parallel to the longitudinal axis of the weight body, and the hook point extends outwardly from the top side near the second end and is oriented generally along the longitudinal axis of the weight body and points towards the first end of the weight body,

a bait keeper means fixedly attached to the second end of the weight body, and

a bait, wherein the bait is removably attached to the weight body through the bait keeper means, and wherein the bait has a longitudinal axis which is generally aligned with the longitudinal axis of the weight body.

In some embodiments, the elongate body of the weight can have a first end and a second end, each of which are generally opposite one another along the first longitudinal axis. In other embodiments, the shank of the hook is generally longitudinally aligned with the first longitudinal axis. In still other embodiments, the eyelet of the hook extends outward from the first end of the weight in an orientation generally parallel to the first longitudinal axis and the hook point extends outward from the second end of the weight in an orientation generally perpendicular to the first longitudinal axis.

In still other embodiments, the bait keeper means is attached to the second end of the weight and is in an orientation that is generally parallel with the first longitudinal axis. The bait keeper means can be a spiral-shaped screw or spike or other suitable shape.

In certain embodiments, the bait is a soft flexible polymer selected from the group consisting of polystyrene, polyvinyl chloride, polyamide (or nylon), synthetic rubber, acrylic, polyethylene, polyfluorethylene, polypropylene, polyurethane, polyethylene terephthalate, polyester, dacron, terylene, plastisol and any combination thereof.

The bait can also be decorated with a paint, a fluorescent paint, a pattern, a line, an image, a design, imitation scales, glitter, foil, or a marking or a combination thereof.

The bait can also include a scent or attractant selected from the group consisting of an animal by-product, a plant by-product, organic compound, or inorganic compound.

The hook of the lure can be positioned such that the point of the hook faces towards the first end or the second end.

The eyelet of the hook can extend from the first end with sufficient exposure to connect to a fishing line.

### BRIEF DESCRIPTION OF THE DRAWINGS

So that those having ordinary skill in the art to which the subject invention pertains will more readily understand how to make and use a soft plastic lure and the method of rigging same as described herein, preferred embodiments thereof will be described in detail herein below, with reference to the drawings, wherein:

FIG. 1 is an embodiment of the weighted soft plastic lure of the invention showing a front perspective view, with the soft bait shown in broken line.

FIG. 2 is an embodiment of the weighted soft plastic lure of the invention showing a side elevation view of the lure, depicted without the soft bait.

FIG. 3 is an embodiment of the weighted soft plastic lure of the invention showing a right end elevation view of the lure, depicted without the soft bait.

FIG. 4 is an embodiment of the weighted soft plastic lure of the invention showing a left end elevation view of the lure, depicted without the soft bait.

FIG. 5 is an embodiment of the weighted soft plastic lure of the invention showing a plan elevation view of the lure, depicted without the soft bait.

FIG. 6 is an embodiment of the weighted soft plastic lure of the invention showing a bottom elevation view of the lure, depicted without the soft bait.

FIG. 7 is an embodiment of the weighted soft plastic lure of the invention showing a rear perspective view of the lure, depicted without the soft bait.

FIG. 8 is an embodiment of the weighted soft plastic lure of the invention showing a front perspective view of the lure, depicted without the soft bait and showing the hook and bait keeper in broken line.

FIG. 9 is an embodiment of the weighted soft plastic lure of the invention showing a rear perspective view of the lure, depicted without the soft bait and showing the hook and bait keeper in broken line.

### DETAILED DESCRIPTION OF PREFERRED EMBODIMENTS

The present invention provides improved weighted jighead soft plastic fishing lures that are easier to rig, provide superior and consistent performance, are imparted with natural movement characteristics when traveling through the water, and are effective in catching many different kinds of fish with less destruction of the bait during a catch.

The lures of the present invention comprise generally two main components: the weighted jighead portion and the bait portion. The term “weighted jighead soft plastic (or soft-bait) lure,” as used herein, refers to a fishing lure comprising at least those two components, i.e., the jighead and the bait. These features are described as follows, and certain embodiments within the scope of the invention are described and shown in the Figures.

### The Weight Jighead

The weighted jighead component of the lures of the invention comprises a weight body, a hook and bait keeper means.

The weight body can be generally any suitable shape, include round, oval, elongated, square, triangular, etc., and any suitable size (e.g., diameter, radius, length, perimeter, area, etc.). In one embodiment, the weight body has an elongated shape having two ends—a first end and a second end. The first end can correspond to the front of the weighted jighead, i.e., the front being the end of the lure that is in contact with the fishing line. The second end of the weight can correspond to the rear of the weighted jighead to which is in contact with a bait, as further described herein. An elongated weight body can be any suitable length, and can be, but is not limited to, about 0.5 inches to about 0.75 inches to about 1 inch to about 1.25 inches to about 1.5 inches to about 1.75 inches to about 2 inches to about 2.25 inches to about 2.5 inches to about 2.75 inches to about 3 inches or more, or any range there in between. The length of the elongate body can even be greater then 3 or 4 or 5 or 6 or more inches.

The weight body can also be of any suitable mass, including, for example, 0.1-0.9 ounces, or 0.5 to 1.5 ounces, or 1.0 to 2.0 ounces, or 1.5 to 3.0 ounces, or 2.0 to 4.0 ounces, or 2.5 to 5.0 ounces, or 3.0 to 6.0 ounces, or 3.5 to 7.0 ounces or 4.0 to 8.0 ounces, or 4.5 to 9.0 ounces, or 5.0 to 10 or more ounces. In one embodiment, the weight body is about 2 ounces, or 4 ounces or 6 ounces.

The weight body can be made from any suitable materials, including metal and ceramic and the like. Metals can include any pure metal or alloy, for example, steel, stainless steel, lead, aluminum, silver, gold, magnesium, zinc, iron, manganese, copper, brass, and the like, or any combination thereof or any alloy comprised of any two or more pure metals in any suitable proportion. Methods for forming the metal weights of the invention will be well known in the art and can be found, for example, in Metalcasting, C. Ammen (author), McGraw-Hill, 2000 and other similar reference guides to metal casting known and readily available in the art.

The weighted jighead also can comprise one or more hooks. The hooks can of any suitable shape, guage, size, or material and is not meant to be limited to any specific type of hook so long as the characteristics of the hook do not preclude the natural-looking movement characteristics of the lures of the invention.

It will be understood by the ordinary person skilled in the art that a fish hook has the following typical anatomy. A typical fishing hook comprises a point, i.e. the sharpened tip of a fish hook which pierces the fish during the catch. Next, moving back from the point is the barb. The fish hook then travels through a “bend” portion, which is a semi-circular looped region that turns back on itself. The bend moves into the “shank” portion, which is the substantially straight portion of the hook which the connects to the end of the fish hook, i.e. the “eye” of the hook. The eye is typically a looped eyelet which functions as a connection point or a fastener to join fish hook to the fishing line and/or leader device. These structures create several known dimensions of a fish hook that are defined here for convenience. The “gape” is the distance between the point and the shank. The “bite” or “throat” of the fishing hook as the distance from the apex of the bend to its intersection with the gape. The “front length” is the distance from the point to the apex of the bend. However, the invention is not limited to the traditional fish hook structure and contemplates any hook design that could be used with the fishing lures of the present invention. For example, some hooks may have an eye or like structure placed along the shank. Other hooks may have more than one barb or barb and point, etc. Still other hooks may have an eye or like structure in the form of a thread or crimp surface or the like.

In one embodiment, the weighted jighead used in the fishing lures of the invention comprise a single hook, such as, a typical worm hook. This type of hook is generally in the shape of the letter “J” and thus, the shank and eyelet of the hook are generally aligned along the same longitudinal path. The hook(s) of the present invention can be positioned anywhere in the jighead and in any orientation. Preferably, in one embodiment, the jighead of the invention comprises a single hook that is embedded in the jighead such that the hook's shank is generally parallel and/or aligned with the longitudinal axis of the weight body of the jighead. In a particular embodiment, the jighead comprises a weight body having an elongated shape with a longitudinal axis and two ends and wherein a hook is embedded in the weight body in manner such that the hook's shank is aligned with the longitudinal axis of the weight body. The hook point or points can extend outwards from the body of the weight in an orientation that is in line with the longitudinal axis of the weight body and wherein the hook point(s) are directed either towards the front end of the body or towards the back of the body, and wherein the exit point of the hook extends either above the longitudinal axis or below the axis. It will be noted that hook points arranged above the longitudinal axis can mitigate against the interference with weeds and other bottom-dwelling plant life in the water column.

Any suitable method or technique can be used to integrate the weight body and the hook(s), including, for example, casting the weight body around a preformed hook such that the hook becomes permanently embedded in the weight body. Alternatively, the weight body can be manufactured such that it has a means for securing a hook. For example, the weight body can be formed with a central channel sufficient to receive a preformed hook and then a means for securing the hook in place, e.g., one or more screws that fasten against the inserted hook. In this manner, the weight body could be fitted with different sized and/or shaped hooks if desired. In addition, it will be appreciated that hook/lure glue can be used to secure the hook to the weight body of the lures of the invention. Hook/lure glue is available and well-known in the art and can include, for example, Pro-Soft Worm Glue or the like. The application of such a glue is well within the skill set of the artisan.

In one preferred embodiment, the weight body comprises a permanently set hook or hooks which are combined during the casting process of the weight body. The hook point(s) extend outward from and above the longitudinal axis of the weight body and are directed towards the front end of the weight body, i.e., the point back towards the end of the lure which is contacted by the fishing line.

The lures of the invention can also comprise additional hooks that are placed in the bait portion.

Preferably, however, the bait of the invention does not comprise any hooks. In a particular embodiment, the jighead hook(s) do not contact the bait, i.e., the jighead hook(s) are not further inserted into the bait portion.

In another aspect, the weighted jighead comprises a bait keeper means. The bait keeper means can be attached at any location to the weight body. Preferably, however, the bait keeper means is joined to the weight body in a manner effective to allow attachment of the bait to the jighead such that the longitudinal axis of the bait is generally aligned with the longitudinal axis of the weight body.

The bait keeper means can be of any suitable shape and can be made from any suitable material. For example, the bait keeper can be any suitable metal or alloy, for example, steel, stainless steel, lead, aluminum, silver, gold, magnesium, zinc, iron, manganese, copper, brass, and the like, or any combination thereof or any alloy comprised of any two or more pure metals in any suitable proportion. The bait keeper should be in a form or shape that allow it to effectively holds the bait against the weighted body of the jighead. For example, the bait keeper can be in the form of a spike, a screw thread or spiral, a sphere, a hook, a loop, a lance, a nail, a staple or the like. Multiple bait keepers can be used, each of which can be the same or different in form and/or shape. In one embodiment, the bait keeper is in the form of a screw thread or spiral. Other suitable shapes and forms will be apparent to those of ordinary skill in the art.

The length and/or size of the bait keeper can be any suitable length and/or size which is sufficient to effectively hold the bait against the jighead. In one aspect, the length and/or size of the bait keeper means can be determined relative to the size of the weight body. For example, in certain embodiments, the bait keeper means (e.g., a screw spiral) is about 10%, or about 20% or about 30% or about 40% or about 50% or more the length of size of the weight body. In one embodiment, the bait keeper means is about 30-50%, or about 30% or about 40% or about 50% the length of the weight body.

In a particular embodiment, the longitudinal axes of the weight body of the jighead, the shank of the hook, the eyelet of the hook and the bait keeper and the bait are generally aligned with one another. In a further embodiment, the bait is connected to the weight body of the jighead via the bait keeper such that the bait forms a generally streamlined shape with the weight body.

### The Bait

The fishing lures of the invention can comprise a bait of any suitable form, shape, size, color, texture, or design, etc. The selection of such parameters will depend, inter alia, upon the type of fishing technique being used and the type of fish that one is attempting to catch. For example, the shape of the bait can resemble a known fresh water or ocean creature, such as, for example, a fish, eel, worm, squid, lizard, crayfish. It is noted that to “resemble” such a creature does not require the lure body to mimic all the anatomical features of a given creature. For example, a lure body that generally resembles a fish is not required to comprise appendages such as the dorsal fin, pelvic fin, spine, fin ray, tail or caudal fin or pectoral fin. In embodiments wherein the bait is in the general shape of a fish, the general shape can reflect any known fish body type, such as, attenuate (tapering gradually to a point, e.g. spiny eel), compressed (a body that is flattened laterally (e.g. flounder), depressed (a body that is flattened dorsoventrally, i.e. from top to bottom (e.g. stingray, skate), fusiform (a spindle-shaped body, referring to the form of fishes that have a body that tapers at both ends (anterior and posterior) and slightly or not at all compressed (e.g. herring, mackerel, tuna), terete (a cylindrical body shape which usually tapers at the end (e.g. eelpout, lamprey) and truncate (cut square and having a flattened broad end (e.g. cowfish, sunfish). Accordingly, the shape of the bait can essentially be reflective of any known type of fish, including the Agnatha (e.g. lamprey and hagfish), Chondrichthyes (sharks, skates and rays) and Osteichthyes (bony fish).

In a one aspect, the bait of the invention is in the form of a fish having an elongate body, without appendages, and is tapered to a degree at the tail region (e.g. attenuate or fusiform in shape). Accordingly, no limitation is meant to be placed on the shape of the lure body so long as it is capable of attracting and/or catching the intended fish.

In another preferred aspect, the bait is in the general form of an eel. In yet another preferred aspect, the bait is in the general form of a herring.

In addition, the present invention contemplates a bait having any suitable length and/or thickness. The bait of the invention is preferably 2-5 inches, 4-7 inches, 6-9 inches, 8-11 inches, 10-13 inches, 12-15 inches, 14-17 inches, 16-19 inches, or more. In certain embodiments, the lure body is 7 inches, 10 inches, or 14 inches. The thickness of the bait portion can vary depending on the particular shape of the bait used.

In a certain aspect, the bait of the invention should have a shape at one end that is suitable for insertion by the bait keeper means such that the bait is joined to the jighead via connection through the bait keeper means to provide a lure whereby their is a seamless or streamlined “look” between the jighead and the bait. In one embodiment, the jighead comprises an elongate body, which is connected via a bait keeper to a bait having an elongate body with a tapered end. The shape of the bait into which the bait keeper is inserted should generally match the shape of the wall of the jighead against which it will be pressed. For example, the wall of the jighead and the end of the bait into which the bait means is inserted can both be flat, or concaved, or convexed, etc.

The bait of the fishing lures of the invention can include any suitable or preferred decorations, including a paint, a fluorescent paint, a pattern, a line, an image, a design, imitation scales, glitter, foil, or a marking. The decorations of the bait may aid the overall lure in appearing more fish-like or which simply may impart a tendency of the lure to better attract a particular type of fish. A suitable decoration may also include any kind of appendage, such as a dangling piece of metal, shiny foil, or the like, which may assist in attraction of fish. Appendages that spin, shine, bubble, twirl or move erratically or move in particular ways that are enticing to fish are also contemplated by the present invention. No limitation is placed on how the fishing lures of the present invention may be “dressed up.” A skilled artisan will appreciate the numerous manners by which to decorate a fishing lure in a way that may enhance a fish's attraction to the lure thereby making the lure more effective. Such decorations can also be fitted on the weight body or the jighead portion of the lures of the invention.

Accordingly, the fishing lures of the present invention are not limited with respect to the styling, e.g. color, glitter, foils, scales, lines, images, patterns, markings, appendages, etc. For example, any color may be used, such as, for example, purple, blue, green, red, orange, yellow, black, amber, bone, etc. In particular aspects, the color of the lure body is black, bubble gum, bone, amber or purple.

The bait and/or jigheads of the invention can also comprise markers, e.g. paint, divet, bump, embossed marking, stamp, sticker, stamping, etc., that mark the locations of the entry and/or exit points of the hooks of the invention and which provide assistance to the person rigging the lure in inserting the lure hook(s) in the proper locations.

In yet another aspect, the bait and/or jigheads of the fishing lures of the invention can be provided with a scent and/or attractant. The scents and/or attractants can be obtained from any natural or synthetic source so long as it achieves the objective of attracting fish or at least having the tendency or likelihood of attracting fish. It will be appreciated that fish scents and/or attractants are commonly provided as liquids or oils which produce an odor which attracts fish, or deceives fish into thinking the artificial fishing lure is actually live or dead bait.

In one aspect, the attractant may be an animal by-product. The animal by-product may be an aquatic animal by-product. In one aspect, the aquatic animal by-product is selected from the group consisting of shrimp, salmon, squid, shad, sardines, anchovies, crayfish, mullet, and pheromones. In a preferred embodiment, animal by-product attractant is capable of attracting striped bass.

In another aspect, the attractant may be a plant by-product. The plant by-product may be an aromatic plant by-product. In a further aspect, the aromatic plant by-product is selected from the group consisting of anise, garlic, banana oil, and pheromones. In a preferred embodiment, the plant-derived attractant is capable of attracting striped bass.

In a still further aspect, the attractant may be an organic or inorganic chemical, or a mixture thereof. The organic chemical may be one or more steroids, fats, fatty acids or a nitrogen containing organic chemical, or any combination thereof. In one aspect, the nitrogen containing organic chemical is selected from the group consisting of alkaloids, amino acids, peptides, quaternary ammonium compounds, proteins and pheromones. In a preferred aspect, the organic chemical attractant is capable of attracting striped bass.

To date, a number of different types of scented lures have been disclosed and any known method or manner to provide a scented lure can be adopted and utilized with the fishing lures of the present invention. For example, the following scented lures are known in the art: lures formed from fish food which provides a scent to attract fish (U.S. Pat. No. 5,063,703 to Riley), lures formed of materials that have been intermixed with scents such as U.S. Pat. No. 4,953,319 to Kasper et. al. (a lure with a fish oil intermixed with the plastic formulation from which the lure made) and U.S. Pat. No. 4,875,305 to Bridges (a slowly dissolving lure made of a polymer with an fish scent attractant impregnated therein) and lures having inner receptacles containing scented substances or fluids such as U.S. Pat. No. 5,170,579 to Hollinger (a lure comprising a pouch for receiving bait or scented substances), U.S. Pat. No. 5,321,906 to Bommarito (a fishing scent delivery system comprising a bladder which releases a fishing scent material in the vicinity of a fishing lure) and U.S. Pat. No. 5,517,781 to Paoletta, Jr. (a lure having a reservoir from which a scented fluid is dispensed). Other types of scent bearing lures include those in which scent impregnated materials not integral to the lure structure are included, such as, U.S. Pat. No. 4,962,609 to Walker (a lure comprising an absorbent fibrous material impregnated with fish attractant), U.S. Pat. No. 5,018,297 to Kennedy, Jr. (a fishing lure with a cellular, porous scent receiving material inserted into a cylinder within the lure) and U.S. Pat. No. 5,142,811 to Freeman (a fishing lure having a fish attractant dispenser such as a scented pipe cleaner inserted into an inner casing). Each of the foregoing references is hereby incorporated by reference.

Accordingly, the scents and/or attractants can be combined together with the baits and/or jighead embodiments of the invention by any known or suitable process, such as those described in the above mentioned references. For example, the scents and/or attractants may be applied on the surface of the lure body and/or the hook assembly at any suitable point in time, such as, for example, at the time of manufacturing of the lure or at the time of rigging the lure. The scents and/or attractants can also be embedded directly in the material used to form the lure body, e.g. mixed together with a liquefied polymer material used to form the lure body prior to pouring a mold for the lure.

The scent and/or attractant can also be combined with the lure body of the invention by way of exterior tabs, strips or foils which contain and release the scent and/or attractant and have the advantage that they can be replenished. Such tabs, strips and foils can be found in U.S. Pat. Nos. 6,827,930, 6,161,324, and 6,079,146, each of which are incorporated herein by reference.

Any suitable material can be used to manufacture or make the bait portion of the fishing lures of the present invention. Most preferably, the lure bodies of the invention are constructed from a soft and/or pliable plastic or polymeric material which are capable of producing movement characteristics that realistically imitate actual live bait. Preferably, the plastics and/or polymeric materials used to construct the baits of the invention are resilient, soft, flexible, and resistant to tearing from normal usage, including during fishing (e.g. when the fish are biting) and during the rigging process. Suitable “soft plastics” for use as starting materials can be found throughout the art. In addition, blends or mixtures of known plastic or polymeric starting materials can be mixed or blended to form a “blend” polymeric material for use in the invention.

Commonly known plastics and/or polymers that can be used to construct the baits of the invention can include, but are not limited to, polystyrene, polyvinyl chloride, polyamide (or nylon), synthetic rubber, acrylic, polyethylene, polyfluorethylene, polypropylene, polyurethane, polyethylene terephthalate, polyester, dacron, terylene and the like or any combinations thereof. Preferably, the plastics and/or polymers of the baits of the invention have soft, pliable, and penetrable properties (e.g., to allow easy and effective connection with the bait keeper means) and they are resistant to tearing (e.g., to avoid destruction by fish).

In one preferred embodiment, the hook(s) of the jighead are not contacted with or inserted into the bait. This advantageously avoids destruction of the bait due to various reasons, including repeat rigging of the bait, casting and/or reeling in the lure, or even tearing due to the fish biting and/or fighting on the line. In addition, the hooks of the invention which are not inserted into the bait have larger gapes exposed, thereby providing a larger hook area to capture fish.

In other embodiments, the hook(s) on the jighead can be inserted into the body of the bait.

Any suitable method known in the art for manufacturing the baits of the invention is contemplated. For example, the baits of the invention can be prepared manually using molds into which hand-poured plastics and/or mixtures or blends of plastics, as described above, can be added and allowed to set or cure. In accordance with various embodiments, scent additives or decorative additives, such as, paints, glitter, etc., as described in more detail elsewhere herein, can be added to the plastics prior to adding the composition to the mold. In addition, the present invention contemplates any automated or semi-automated industrial process for making the baist of the invention, which utilizes any suitable machinery that is typical in the art of plastics, such as automated an injection molding machine, such as, for example, U.S. Pat. No. 4,444,711. In addition, any bait can be used whether it be obtained commercially or prepared by the user according to the above methods, so long as the bait is attachable to the jighead in the manner required above, e.g., so that the longitudinal axis of the bait is maintained generally aligned with the longitudinal axis of the jighead's weight body to enable for a more natural movement characteristic of the lure in the water.

### Use of the Lures of the Invention

In use, the bait can be attached to the jighead by securing the bait onto the bait keeper means by any suitable means. For example, the bait can be secured to a jighead having a screw-shaped spiral bait keeper by easily twisting the bait body onto the bait keeper until the bait abuts the end of the jighead. The method of rigging can also include the step of applying glue to the bait keeper to assist in the securement of the bait to the jighead. It will be readily appreciated that lure glue, such as Pro-Soft Worm Glue, can be applied to the bait keeper and/or bait to help prevent the bait from slipping off the keeper.

Due to the ease of securing the bait to the jighead, different baits can easily be substituted into the same jighead assembly during a single fishing trip. The choice of bait style, shape, etc., will be determined largely by the fisherman and the types of fishing conditions present at the time of use.

The lures of the present invention can be used to fish any suitable target fish, such as, for example, striped bass (any geographical region), weakfish (e.g. Long Island, N.Y.), Musky and Northern Pike (e.g. Northern Maine), Mahi-Mahi (e.g. Florida), King Fish (e.g. Florida), Snook (e.g. Florida), Blue Fin Tuna (e.g. Massachusetts), Largemouth Bass (e.g. Florida or Massachusetts), and Bluefish (any geographical region). The lures can be used for both fresh and salt water fishing.

The present invention contemplates any technique or fishing style that is suitable for use with the inventive lures. For example, the inventive lures can be fished with a traditional jerk approach. In this method, the rod tip is pointed towards the water and inventive lure is caused to twitch as the lure is reeled in using short jerking motions. A pause can be introduced in the reeling to simulate a substantially wounded bait fish. The retrieve speed of the reel can be changed and the twitching frequencies can be adjusted to facilitate a catch. With the “dead drift” technique, which can be used in areas with strong currents, the fishing line that is connected to the inventive lure comprises as little “belly” or slack in the line as possible while also letting the tide carry the lure. The lure can be caused to twitch as it begins to swing inwards towards the fisherman. With a “surface noise” technique, one fishes with tip of the rod up while employing a fast retrieve. Often, in very calm or slack water, this surface noise technique can be combined with a traditional jerk approach. This description of possible techniques is not meant to limit in any way the approach or style of fishing that may be employed by a fisherman with the lures of the present invention. Any technique is possible and the skilled artisan will have the capacity to select or use any suitable approach in the use of the lures of the invention.

In a particular embodiment, the lures of the present invention are suitable for fishing at points at deeper levels in the water column. The features of the lures, including the general alignment of the jighead and bait along the same longitudinal axis, allows for a more natural, side-to-side movement characteristic imparted on the lure, which more closely imitates actual live bait and is more attractive to fish. The lures of the invention can also be fished using a “walk-the-dog” style while advantageously maintaining a highly realistic look of the bait. With this technique, the rod is struck down to the left, creating slack in the line, which is wound in. This technique is repeated by striking the rod down to the right and winding in the slack created by this action. This moves the lure in a zig zag pattern through the water. And, with the lures of the present invention, the movement is coupled with a realistic side-to-side movement characteristic of the live bait that are being imitated by the soft plastics. Advantageously, the present lures of the invention tend avoid unnatural up and down movement characteristics which are problematic with other types of prior art jighead lures.

The present invention further contemplates a package that comprises a weighted jighead lure of the invention as described and claimed herein, along with suitable instructions for rigging the lure. The bait and jighead portions can be separately packaged and sold separately or they can be packaged together. The package may also comprise one or more decorations, and one or more attractants. The package can also include other features, such as, additional weights, leaders and fishing line, certain decorations, including, for example, rattles. In addition, the package can include a fishing lure glue, such as, Pro-Soft Worm Glue, which can be used to secure the hook assembly to the lure body so that the lure body does not slide along the bait keeper means.

Specific embodiments of the invention are now described in relation to the drawings provided herein wherein like reference numbers identify similar structural features of various embodiments of the subject invention.

Collectively, the figures show different views of an embodiment of the weighted jighead soft plastic fishing lures of the invention.

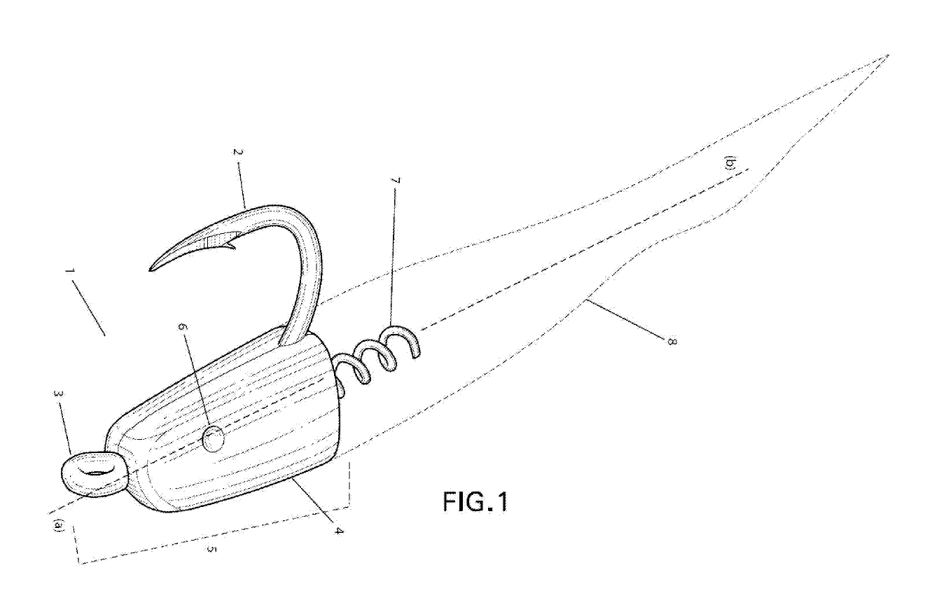

FIG. 1 shows a front perspective view of an embodiment of the lure 1 of the invention. The figures shows a hook 2 having an eyelet 3 embedded permanently in a weight body 4 of the jighead 5, wherein the weight body 4 has a first longitudinal axis (a). The jighead 5 also includes a decorative eye 6 and a bait keeper means 7, which is attached to the back end of the weight body 4. In this embodiment, the bait keeper means 7 is in the form of a screw spiral or helix, but can be any shape or form, including, for example, a spike, lance, or pin. The lure also includes a soft plastic lure bait 8 which can be attached or mounted to the jighead via the bait keeper means. The longitudinal axis (b) of the bait 8 is generally aligned with the longitudinal axis (a) of the weight body 4 and the shank of the hook (not labelled or shown as it is seen embedded in the weight body).

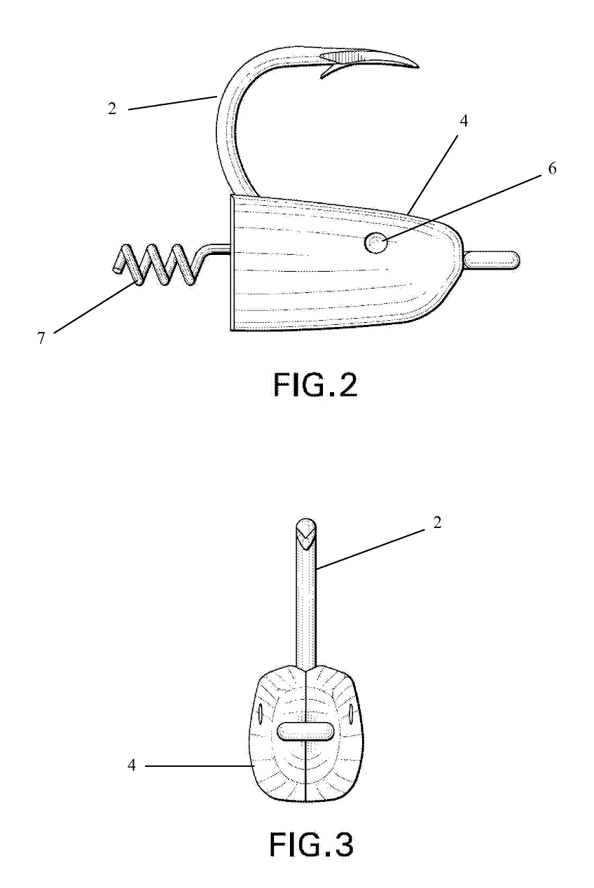

FIG. 2 shows a side elevation view of the lure of FIG. 1.

FIG. 3 shows a right end elevation view of the lure of FIG. 1.

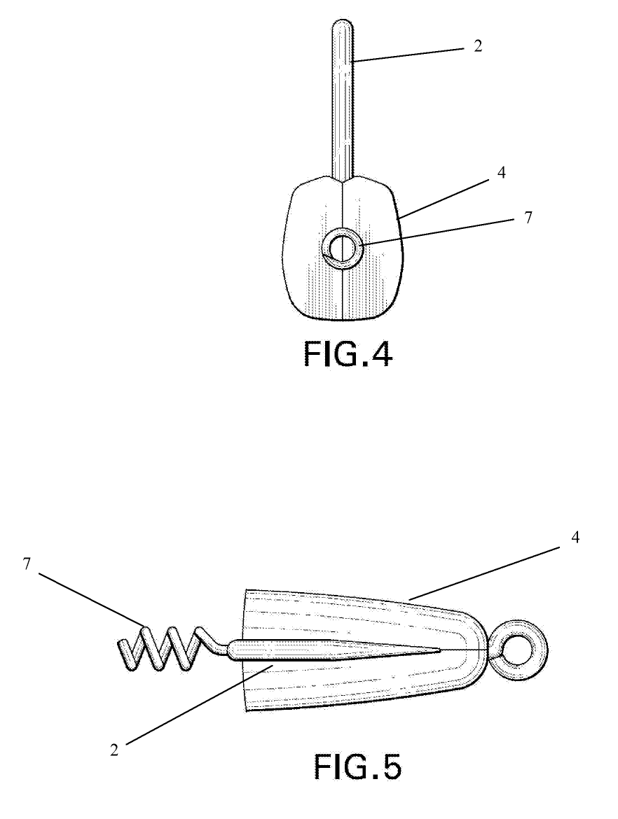

FIG. 4 shows a left end elevation view of the lure of FIG. 1.

FIG. 5 shows a plan elevation view of the lure of FIG. 1.

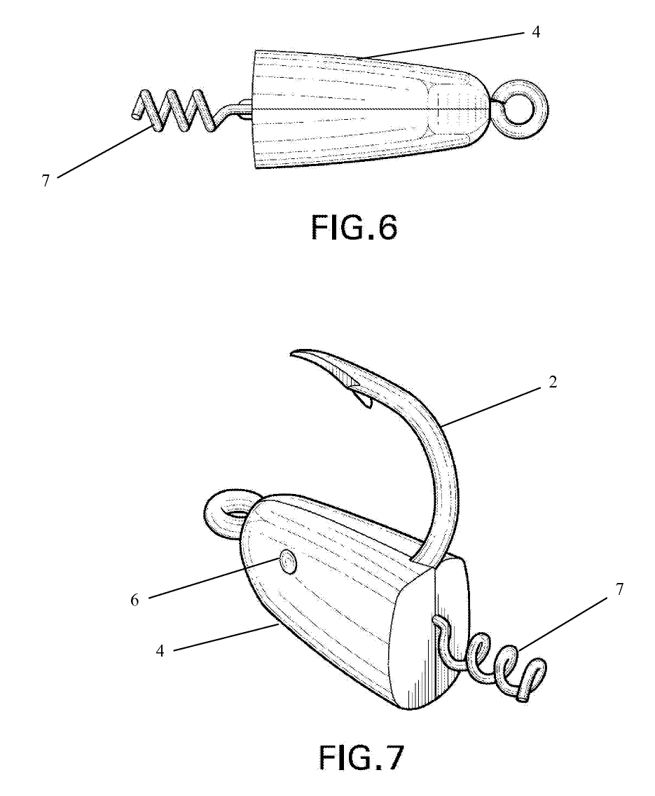

FIG. 6 shows a bottom elevation view of the lure of FIG. 1.

FIG. 7 shows a rear perspective view of the lure of FIG. 1.

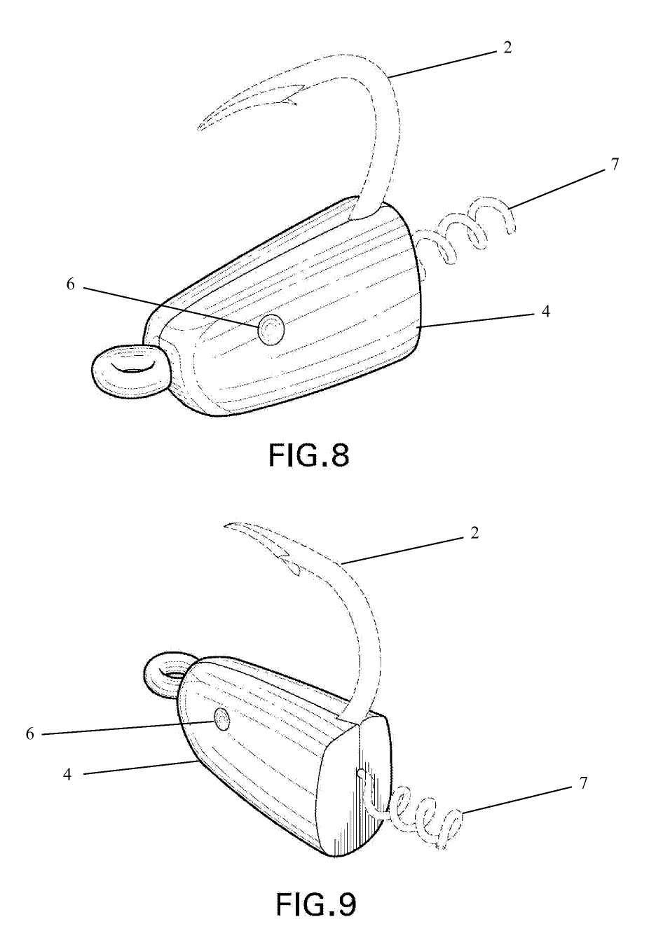

FIG. 8 shows a front perspective view of the lure of FIG. 1, depicted without the soft bait and showing the hook and bait keeper in broken line.

FIG. 9 shows a rear perspective view of the lure of FIG. 1, depicted without the soft bait and showing the hook and bait keeper in broken line.

Although the device of the subject invention has been described with respect to preferred embodiments, those skilled in the art will readily appreciate that changes and modifications may be made thereto without departing from the spirit and scope of the subject invention as defined by the appended claims.

1. A fishing lure comprising:
a jighead assembly, comprising a weight having a generally elongate body with a first longitudinal axis, a hook and a bait keeper means, and
a bait having a generally elongate body with a second longitudinal axis, wherein the bait is releasably connected to the jighead assembly at the bait keeper means such that the first longitudinal axis of the weight and the second longitudinal axis of the bait are generally in line with one another.

2. The fishing lure of claim 1, wherein the generally elongate body of the weight comprises a first end and a second end, each of which are generally opposite one another along the first longitudinal axis.

3. The fishing lure of claim 1, wherein the shank of the hook is generally longitudinally aligned with the first longitudinal axis.

4. The fishing lure of claim 1, wherein the eyelet of the hook extends outward from the first end of the weight in an orientation generally parallel to the first longitudinal axis and the hook point extends outward from the second end of the weight in an orientation generally perpendicular to the first longitudinal axis.

5. The fishing lure of claim 1, wherein the bait keeper means is attached to the second end of the weight and is in an orientation that is generally parallel with the first longitudinal axis.

6. The fishing lure of claim 1, wherein the bait keeper means is a spiral-shaped screw.

7. The fishing lure of claim 1, wherein the bait keeper means is a spike.

8. The fishing lure of claim 1, wherein the bait is a soft flexible polymer selected from the group consisting of polystyrene, polyvinyl chloride, polyamide (or nylon), synthetic rubber, acrylic, polyethylene, polyfluorethylene, polypropylene, polyurethane, polyethylene terephthalate, polyester, dacron, terylene, plastisol and any combination thereof.

9. The fishing lure of claim 1, wherein the bait is decorated with a paint, a fluorescent paint, a pattern, a line, an image, a design, imitation scales, glitter, foil, or a marking or a combination thereof.

10. The fishing lure of claim 1, wherein the bait comprises a scent or attractant selected from the group consisting of an animal by-product, a plant by-product, organic compound, or inorganic compound.

11. The fishing lure of claim 1, wherein the point of the hook faces towards the first end.

12. The fishing lure of claim 1, wherein the point of the hook faces towards the second end.

13. The fishing lure of claim 1, wherein the eyelet of the hook extends from the first end with sufficient exposure to connect to a fishing line.

14. A fishing lure, comprising:
a weight body having a generally elongate body with a longitudinal axis, a first end and a second end, wherein the two ends are generally opposite one another along the first longitudinal axis, a top side, a bottom side, a left side and a right side,
a hook, wherein the hook passes through the weight body such that the eyelet of the hook extends outward from the first end of the weight body, the hook flank is generally parallel to the longitudinal axis of the weight body, and the hook point extends outwardly from the top side near the second end and is oriented generally along the longitudinal axis of the weight body and points towards the first end of the weight body,
a bait keeper means fixedly attached to the second end of the weight body, and
a bait, wherein the bait is removably attached to the weight body through the bait keeper means, and wherein the bait has a longitudinal axis which is generally aligned with the longitudinal axis of the weight body.

15. The fishing lure of claim 14, wherein the bait keeper means is attached to the second end of the weight and is in an orientation that is generally parallel with the first longitudinal axis.

16. The fishing lure of claim 14, wherein the bait keeper means is a spiral-shaped screw.

17. The fishing lure of claim 14, wherein the bait keeper means is a spike.

18. The fishing lure of claim 14, wherein the bait is a soft flexible polymer selected from the group consisting of polystyrene, polyvinyl chloride, polyamide (or nylon), synthetic rubber, acrylic, polyethylene, polyfluorethylene, polypropylene, polyurethane, polyethylene terephthalate, polyester, dacron, terylene, plastisol and any combination thereof.

19. The fishing lure of claim 14, wherein the bait is decorated with a paint, a fluorescent paint, a pattern, a line, an image, a design, imitation scales, glitter, foil, or a marking or a combination thereof.

20. The fishing lure of claim 14, wherein the bait comprises a scent or attractant selected from the group consisting of an animal by-product, a plant by-product, organic compound, or inorganic compound.

21. The fishing lure of claim 14, wherein the eyelet of the hook extends from the first end with sufficient exposure to connect to a fishing line.
